(19) United States
(12) Patent Application Publication
(10) Pub. No.: US 2025/0141050 A1
(43) Pub. Date: May 1, 2025

(54) ELASTIC SHEET FOR ALL SOLID-STATE BATTERY AND ALL SOLID-STATE BATTERY INCLUDING THE SAME

(71) Applicant: SAMSUNG SDI CO., LTD., Yongin-si (KR)

(72) Inventors: Ik Hwan CHO, Yongin-si (KR); Jiwan YOU, Yongin-si (KR); Changhee WOO, Yongin-si (KR); Jinhwan PARK, Yongin-si (KR); Young Gyoon RYU, Yongin-si (KR)

(21) Appl. No.: 18/825,098

(22) Filed: Sep. 5, 2024

(30) Foreign Application Priority Data
Nov. 1, 2023 (KR) 10-2023-0149241

(51) Int. Cl. H01M 50/486; H01M 50/477; H01M 50/483; H01M 50/489

(52) U.S. Cl. CPC H01M 50/486; H01M 50/477; H01M 50/483; H01M 50/489

(57) ABSTRACT

An elastic sheet for an all-solid-state battery and an all-solid-state battery including the elastic sheet for an all-solid-state battery, the elastic sheet for an all-solid-state battery includes a (meth)acrylate copolymer; an aluminum hydroxide; and inorganic nanotubes, and the all-solid-state battery includes the elastic sheet; and an electrode assembly, wherein the electrode assembly includes a positive electrode, a negative electrode, and a solid electrolyte layer between the positive electrode and the negative electrode, and the elastic sheet is outside at least one of the positive electrode and the negative electrode.

### CROSS-REFERENCE TO RELATED APPLICATION

This application claims priority to and the benefit of Korean Patent Application No. 10-2023-0149241 filed in the Korean Intellectual Property Office on Nov. 1, 2023, the entire contents of which are incorporated herein by reference.

### BACKGROUND

### 1. Field

Embodiments relate to an elastic sheet for an all-solid-state battery and an all-solid-state battery including the same.

### 2. Description of the Related Art

Rechargeable lithium batteries may be recharged and may have three or more times higher energy density per unit weight than a lead storage battery, nickel-cadmium battery, nickel hydrogen battery, nickel zinc battery or the like. It may also be highly charged and thus, may be commercially manufactured for a laptop, a cell phone, an electric tool, an electric bike, or the like, and research on improvement of additional energy density has been actively made.

### SUMMARY

Embodiments are directed to an elastic sheet for an all-solid-state battery, including a (meth)acrylate copolymer; aluminum hydroxide; and inorganic nanotubes.

The aluminum hydroxide may be included in an amount of about 100 to about 300 parts by weight, based on 100 parts by weight of the (meth)acrylate copolymer, and the inorganic nanotubes may be included in an amount of about 0.01 to about 1 part by weight, based on 100 parts by weight of the (meth)acrylate copolymer.

The (meth)acrylate copolymer may include a first structural unit of a C1 to C20 linear alkyl (meth)acrylate, a second structural unit of a C1 to C20 cyclic alkyl (meth)acrylate, and a third structural unit of a C1 to C20 alkyl (meth)acrylate including a hydroxy group.

The first structural unit may be included in an amount of about 30 wt % to about 70 wt %, based on a total weight of the (meth)acrylate copolymer, the second structural unit may be included in an amount of about 5 wt % to about 30 wt %, based on the total weight of the (meth)acrylate copolymer, and the third structural unit may be included in an amount of about 20 wt % to about 50 wt %, based on the total weight of the (meth)acrylate copolymer.

The (meth)acrylate copolymer may be a copolymer of 2-ethylhexyl (meth)acrylate, isobornyl (meth)acrylate, and 2-hydroxybutyl (meth)acrylate.

The inorganic nanotubes may include boehmite nanotubes, alumina nanotubes, boron nitride nanotubes, or a combination thereof.

An aspect ratio of the inorganic nanotube may be greater than or equal to about 3.

The elastic sheet may further include an additive, and the additive may be a crosslinking agent, an inorganic particle, a flame retardant, a pore-forming agent, or a combination thereof.

The elastic sheet includes the crosslinking agent, and the crosslinking agent may be a multi-functional (meth)acrylate.

The crosslinking agent may be included in an amount of about 0.01 parts by weight to about 1 part by weight, based on 100 parts by weight of the (meth)acrylate copolymer.

The elastic sheet may include the inorganic particle and the inorganic particle may include boehmite, alumina, or a combination thereof.

The inorganic particle may be included in an amount of about 30 parts by weight to about 70 parts by weight, based on 100 parts by weight of the (meth)acrylate copolymer.

The elastic sheet may include the flame retardant and the flame retardant may include a phosphorus flame retardant or a melamine flame retardant.

The flame retardant may be included in an amount of about 1 part by weight to about 30 parts by weight, based on 100 parts by weight of the (meth)acrylate copolymer.

The elastic sheet may include the pore-forming agent, and the pore-forming agent may be an inorganic pore-forming agent, an organic pore-forming agent, or a combination thereof.

A D50 particle size of the additive excluding the flame retardant may be about 300 nm to about 20 μm.

The elastic sheet may be in a form of foam or a dense layer.

The elastic sheet may be in the form of foam, CFD 40%, a compressive strength measured at a point compressed to 60% of an initial thickness, may be about 0.5 to about 3 MPa, a stress relief rate according to Equation 1 may be about 5 to about 20%, a recovery rate according to Equation 2 may be about 60 to about 95%, a vertical thermal conductivity of the elastic sheet may be about 0.3 to about 2 W/mK, and a horizontal thermal conductivity of the elastic sheet is about 1.5 to about 5 W/mK,

Stress relief rate=100*(Stress after 60 seconds when compressed to 40% of initial thickness)/(Initial stress when compressed to 40% of initial thickness), and [Equation 1]

Recovery rate=100*(Stress upon restoration to 60% of an initial thickness after compression to 40% of an initial thickness)/(Initial stress after compression to 60% of an initial thickness). [Equation 2]

The elastic sheet may be in the form of a dense layer, CFD 40%, a compressive strength measured at a point compressed to 60% of an initial thickness, may be about 0.5 to about 4 MPa, a stress relief rate according to Equation 1 may be about 5 to about 20%, a recovery rate according to Equation 2 may be about 60 to about 98%, a vertical thermal conductivity of the elastic sheet may be about 0.5 to about 2 W/mK, and a horizontal thermal conductivity of the elastic sheet may be about 3 to about 15 W/mK,

Stress relief rate=100*(Stress after 60 seconds when compressed to 40% of initial thickness)/(Initial stress when compressed to 40% of initial thickness), and [Equation 1]

Recovery rate=100*(Stress upon restoration to 60% of an initial thickness after compression to 40% of an initial thickness)/(Initial stress after compression to 60% of an initial thickness). [Equation 2]

The embodiments may be realized by providing an all-solid-state battery, including the elastic sheet; and an electrode assembly, wherein the electrode assembly includes a positive electrode, a negative electrode, and a solid electrolyte layer between the positive electrode and the negative electrode, and the elastic sheet is outside at least one of the positive electrode and the negative electrode.

### BRIEF DESCRIPTION OF THE DRAWINGS

Features will become apparent to those of skill in the art by describing in detail exemplary embodiments with reference to the attached drawings in which:

FIGS. 1 and 2 are cross-sectional views schematically showing all-solid-state batteries according to embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, when specific definition is not otherwise provided, the singular may also include the plural. In addition, unless otherwise specified, “A or B” may mean “including A, including B, or including A and B.”

As used herein, “combination thereof” may mean a mixture of constituents, a laminate, a composite, a copolymer, an alloy, a blend, or a reaction product.

As used herein, (meth)acrylate is a concept that includes acrylate and methacrylate.

As used herein, when a definition is not otherwise provided, particle diameter may be an average particle diameter. This average particle diameter means an average particle diameter (D50), which may be a diameter of particles with a cumulative volume of 50 volume % in the particle size distribution. The average particle diameter (D50) may be measured by a suitable method, e.g., by measuring with a particle size analyzer, a transmission electron microscope or scanning electron microscope, or a scanning electron microscope. Alternatively, a dynamic light-scattering measurement device may be used to perform a data analysis, and the number of particles may be counted for each particle size range. From this, the average particle diameter (D50) value may be easily obtained through a calculation. A laser diffraction method may also be used. When measuring by laser diffraction, more specifically, the particles to be measured may be dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle diameter (D50) based on 50% of the particle size distribution in the measuring device may be calculated.

As used herein, “weight average molecular weight” may be a value measured by gel permeation chromatography (GPC, PL GPC220, Agilent Technologies) and corrected with a cubic function using polystyrene.

As used herein, “thickness” may be measured through a photograph taken with an optical microscope such as a scanning electron microscope, or may be measured using a thickness gauge.

### (Elastic Sheet)

Some embodiments provide an elastic sheet for an all-solid-state battery including a (meth)acrylate copolymer; aluminum hydroxide; and inorganic nanotubes.

The elastic sheet according to some embodiments may help prevent damage to a solid electrolyte during the manufacturing process of the all-solid-state battery or the charging and discharging process of the manufactured all-solid-state battery, while allowing the components of the electrode assembly to have a uniform temperature, thereby improving cycle-life characteristics and coulombic characteristics of an all-solid-state battery. Hereinafter, an elastic sheet according to some embodiments will be described in detail.

### (Meth)acrylate Copolymer

The (meth)acrylate copolymer may be a component that forms the basic skeleton of an elastic sheet and may be a polymer with excellent stress relief characteristics. In an implementation, the elastic sheet including the (meth)acrylate copolymer may help improve cycle-life characteristics of the all-solid-state battery by suppressing breakage of the solid electrolyte during the manufacturing process of the all-solid-state battery or the charging and discharging process of the manufactured all-solid-state battery.

The (meth)acrylate copolymer may be a terpolymer including a first structural unit of a C1 to C20 linear alkyl (meth)acrylate, a second structural unit of a C1 to C20 cyclic alkyl (meth)acrylate, and a third structural unit of a C1 to C20 alkyl (meth)acrylate including a hydroxy group.

Based on a total weight of the (meth)acrylate copolymer, the first structural unit may be included in an amount of about 30 wt % to about 70 wt %, or about 40 wt % to about 60 wt %; the second structural unit may be included in an amount of about 5 wt % to about 30 wt %, or about 10 wt % to about 20 wt %; and the third structural unit may be included in an amount of about 20 wt % to about 50 wt %, or about 30 wt % to about 40 wt %. Maintaining the amounts of monomers in the above ranges may help ensure stress relief characteristics and restoration properties of the (meth)acrylate copolymer may be excellently exhibited.

In an implementation, the C1 to C20 linear alkyl (meth)acrylate may be, e.g., 2-ethylhexyl (meth)acrylate, 2-ethylpentyl (meth)acrylate, 2-ethylheptyl (meth)acrylate, 2-ethylnonyl (meth)acrylate. In an implementation, it may be, e.g., acrylate, 2-propylhexyl (meth)acrylate, 2-propyoctyl (meth)acrylate, or a combination thereof.

In an implementation, the C1 to C20 cyclic alkyl (meth)acrylate may be, e.g., isobornyl (meth)acrylate, cyclohexyl (meth)acrylate, cyclopentyl (meth)acrylate, or a combination thereof.

In an implementation, the C1 to C20 alkyl (meth)acrylates including the hydroxy group may be, e.g., 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof. In an implementation, the (meth)acrylate copolymer may be a copolymer of 2-ethylhexyl (meth)acrylate, isobornyl (meth)acrylate, and 2-hydroxybutyl (meth)acrylate. The (meth)acrylate copolymer may have a weight average molecular weight of about 400,000 g/mol to about 2,000,000 g/mol as measured by GPC method.

### Aluminum Hydroxide

The aluminum hydroxide may be a component with excellent heat conduction characteristics. In an implementation, an elastic sheet including the aluminum hydroxide may improve coulombic characteristics of an all-solid-state battery by ensuring a uniform temperature of components of an electrode assembly.

Based on 100 parts by weight of the (meth)acrylate copolymer, the aluminum hydroxide may be included in an amount of about 100 parts by weight to about 300 parts by weight or about 100 parts by weight to about 200 parts by weight. Maintaining the amount of the aluminum hydroxide in these ranges may help ensure the cycle-life characteristics and the coulombic characteristics of the all-solid-state battery may be harmoniously improved.

### Inorganic Nanotubes

The inorganic nanotubes may be a component having excellent heat conduction characteristics like the aluminum hydroxide. In the case of spherical inorganic particles, a large amount may be required to connect different media. In an implementation, inorganic nanotubes, even in a small amount, may connect different media.

In an implementation, the inorganic nanotubes may be advantageous in terms of heat conduction, compared with the spherical inorganic particles. In an implementation, an elastic sheet including the inorganic nanotubes may help ensure a uniform temperature of components of an electrode assembly and thereby, help improve coulombic characteristics of an all-solid-state battery.

In an implementation, the inorganic nanotubes may be boehmite nanotubes, alumina nanotubes, boron nitride nanotubes, or a combination thereof. In an implementation, the inorganic nanotubes may be boehmite nanotubes.

The inorganic nanotubes may have an aspect ratio of, e.g., greater than or equal to about 3, greater than or equal to about 10, greater than or equal to about 20, or greater than or equal to about 30. An aspect ratio upper limit of the inorganic nanotubes may be, e.g., less than or equal to about 60, less than or equal to about 50, or less than or equal to about 40.

Based on 100 parts by weight of the (meth)acrylate copolymer, the inorganic nanotubes may be included in an amount of, e.g., about 0.01 parts by weight to about 1 part by weight or about 0.1 parts by weight to about 0.3 parts by weight. Maintaining the amount of inorganic nanotubes in these ranges may help ensure the cycle-life characteristics and the coulombic characteristics of the all-solid-state battery may be harmoniously improved.

### Additives

The elastic sheet may further include additives. In an implementation, the additive may be a crosslinking agent, inorganic particles, a flame retardant, a pore-forming agent, or a combination thereof.

### Crosslinking Agent

The crosslinking agent may form a network-structured polymer through intermolecular and/or intramolecular chemical bonds of the (meth)acrylate copolymer. Accordingly, the elastic sheet further including the crosslinking agent may have improved resilience. In an implementation, the crosslinking agent may be a multi-functional (meth)acrylate. In an implementation, the crosslinking agent may be 1,6-hexanediol di(meth)acrylate.

Based on 100 parts by weight of the (meth)acrylate copolymer, the crosslinking agent may be included in an amount of about 0.01 parts by weight to about 1 part by weight, about 0.05 parts by weight to about 0.5 parts by weight, or about 0.1 parts by weight to about 0.3 parts by weight. Maintaining the amount crosslinking agent in the above ranges may help ensure that the mechanical properties of the elastic sheet may be improved.

### Inorganic Particles

The elastic sheet further including the inorganic particles may have improved compressive strength. The inorganic particles may be boehmite, alumina, or a combination thereof. In an implementation, the inorganic particle may be boehmite. The inorganic particle may have a sphere shape, and in this case, D50 may be, e.g., about 100 nm to about 500 nm. In an implementation, the inorganic particle may be boehmite.

Based on 100 parts by weight of the (meth)acrylate copolymer, the inorganic particles may be included in an amount of, e.g., about 30 parts by weight to about 70 parts by weight, or about 40 parts by weight to about 60 parts by weight. Maintaining the amount of inorganic particles in the above ranges may help ensure that the compressive strength of the elastic sheet may be improved.

### Flame Retardant

The flame retardant may be a substance used to reduce flammability or delay combustion. In an implementation, the flame retardancy of the elastic sheet further including the flame retardant may be improved. The flame retardant may be a phosphorus flame retardant or a melamine flame retardant. In an implementation, the flame retardant may be aluminum diethylphophinate that is a type of phosphorus flame retardant.

Based on 100 parts by weight of the (meth)acrylate copolymer, the flame retardant may be included in an amount of, e.g., about 1 part by weight to about 30 parts by weight, or about 5 parts by weight to about 20 parts by weight. Maintaining the amount of flame retardant in the above ranges may help ensure that the flame retardancy of the elastic sheet may be improved.

### Pore-Forming Agent

The pore-forming agent may form pores inside the elastic sheet. In an implementation, the elastic sheet further including the pore-forming agent may be in the form of a foam with pores formed therein. In an implementation, an elastic sheet that does not include the pore-forming agent may be in the form of a dense layer with no pores formed therein.

In an implementation, the elastic sheet in the form of foam may help ensure that impact resistance and stress relief characteristics may be increased. In an implementation, the elastic sheet in the form of a dense layer may help ensure that compressive strength and thermal conductivity may be improved. Accordingly, whether or not to use the pore-forming agent can be determined depending on the desired characteristics. The pore-forming agent may be an inorganic pore-forming agent, an organic pore-forming agent, or a combination thereof. As used herein, the term “hollow” refers to a hollow shape.

The inorganic pore-forming agent may be glass microspheres. In an implementation, the glass microspheres may be glass bubbles. The glass bubble may be a hollow particle made of glass. The organic pore-forming agent may be a thermally expandable polymer microsphere. The thermally expandable polymer microsphere may have a form of a capsule having a hollow and a shell, and a liquid having a boiling point below the softening temperature of the shell is included in the hollow for foaming.

The liquid included in the hollow of the thermally expandable polymer microsphere may include hydrocarbons, e.g., n-butane, isobutane, n-pentane, neopentane, isopentane, hexane, isohexane, heptane, octane, cyclopentane, cyclopentene, 1-pentene, and 1-hexene. In an implementation, hydrocarbons with a boiling point of less than 60° under atmospheric pressure may be desirable. In an implementation, the liquid included in the hollow may be isobutane.

The shell of the thermally expandable polymer microsphere may include an acrylic copolymer, e.g., an acrylonitrile copolymer. The thermally expandable polymer microsphere is in a form of a general powder at room temperature, but when exposed to high temperatures, the liquid included in the hollow of the thermally expandable polymer microsphere vaporizes and expands the capsule, so that it can be applied as a foaming agent.

The thermally expandable polymer microsphere may expand at about 150° C. to about 200° C., expanding their volume by about 50 to about 100 times their initial size. In an implementation, the thermally expandable polymer microsphere may be expanded to an expanded polymer microsphere.

Based on 100 parts by weight of the (meth)acrylate copolymer, the glass microsphere may be included in an amount of, e.g., about 0.1 parts by weight to about 5 parts by weight, or about 1 parts by weight to about 2 parts by weight; and the polymer microsphere may be included in an amount of about 0.01 parts by weight to about 5 parts by weight, or about 0.1 parts by weight to about 1.5 parts by weight. Maintaining the amounts of the glass microsphere and the polymer microsphere in the above ranges may help ensure that pores may be formed within an appropriate range within the elastic sheet.

### D50 Particle Size of Additive

The D50 particle size of the additive excluding the flame retardant may be about 300 nm to about 20 μm.

### Physical Properties of Elastic Sheet

The elastic sheet may exhibit excellent compressive strength, stress relief rate, recovery rate, and thermal conductivity.

### Compressive Strength

Hereinafter, CFD (Compression Force Deflection) n % means the compressive strength measured according to ASTM D3574 at the point compressed to become (100-n) % of the initial thickness. In an implementation, the elastic sheet may be in the form of foam and the CFD 40% may be, e.g., about 0.5 MPa to about 3 MPa, or about 2 MPa to about 2.5 MPa. In an implementation, the elastic sheet may be in the form of a dense layer and the CFD 40% may be, e.g., about 0.5 MPa to about 4 MPa, or about 2.5 MPa to about 3 MPa.

Examples of measurement of CFD (Compression Force Deflection) n % are as follows.

The elastic sheet may be manufactured into a specimen with dimensions of width*length=2 cm*2 cm, and a compression may be performed at a compression rate of 0.6 mm/min (10 μm/sec) using a compression tester with a spherical jig with a diameter of 10 mm.

For elastic sheet specimens, CFD n % may be measured using UTM (manufacturer: Shimadzu Scientific Korea Corp.) according to ASTM D3574 at the point in time when compressed to (100-n) % of the initial thickness after pressing.

### Stress Relief Rate

In an implementation, the elastic sheet may be in the form of foam and the stress relief rate according to Equation 1 may be, e.g., about 5% to about 20%, about 7% to about 15%, or about 7.5% to about 8.5%.

In an implementation, the elastic sheet may be in the form of a dense layer and the stress relief rate according to Equation 1 may be, e.g., about 5% to about 20%, about 7% to about 15%, or about 5.5% to about 6.5%.

Stress relief rate=100*(Stress after 60 seconds when compressed to 40% of initial thickness)/(Initial stress when compressed to 40% of initial thickness) [Equation 1]

Examples of measurement of stress relief rate are as follows.

The elastic sheet may be manufactured into a specimen with dimensions of width*length=2 cm*2 cm, and compression may be performed at a compression rate of 0.6 mm/min (10 μm/sec) using a compression tester with a spherical jig with a diameter of 10 mm.

The elastic sheet specimen may be measured with respect to initial stress at a point of being compressed to 40% of its initial thickness. In an implementation, the elastic sheet specimen may be measured with respect to stress after 60 seconds from a point of being compressed to 40% of its initial thickness. Herein, the stress at each point may be measured by using TA (Texture Analyzer, manufacturer: Stable Micro Systems). The stress measurement values at each point are inserted into Equation 1 to obtain a stress relief rate.

### Recovery Rate

In an implementation, the elastic sheet may be in the form of foam and the recovery rate according to Equation 2 may be, e.g., about 60% to about 95%, about 65% to about 90%, or about 75% to about 80%.

In an implementation, the elastic sheet may be in the form of a dense layer and the recovery rate according to Equation 2 may be, e.g., about 60% to about 98%, about 70% to about 95%, or about 85% to about 90%.

Recovery rate=100*(Stress upon restoration to 60% of the initial thickness after compression to 40% of the initial thickness)/(Initial stress after compression to 60% of the initial thickness) [Equation 2]

Examples of measurement of the recovery rate are as follows.

The elastic sheet may be manufactured into a specimen with dimensions of width*length=2 cm*2 cm, and compression may be performed at a compression rate of 0.6 mm/min (10 μm/sec) using a compression tester with a spherical jig with a diameter of 10 mm.

The elastic sheet specimen may be measured with respect to initial stress at a point of being compressed to 60% of its initial thickness. In addition, the elastic sheet specimen compressed to 40% of its initial thickness may be measured with respect to stress at a point of being recovered to 60%. Herein, the stress at each point may be measured by using TA (Texture Analyzer, manufacturer: Stable Micro Systems). The stress measurement values at each point were inserted into Equation 2 to obtain a recovery rate.

### Thermal Conductivity

In an implementation, the elastic sheet may be in the form of a foam and the elastic sheet may have vertical thermal conductivity of, e.g., about 0.3 W/mK to about 2 W/mK or about 0.3 W/mK to about 1 W/mK; and horizontal thermal conductivity of about, e.g., 1.5 W/mK to about 5 W/mK or about 2 to about 4 W/mK

In an implementation, the elastic sheet is a dense layer and the elastic sheet may have vertical thermal conductivity of, e.g., about 0.5 W/mK to about 2 W/mK or about 0.8 W/mK to about 1.5 W/mK; and horizontal thermal conductivity of about 3 W/mK to about 15 W/mK or about 6 to about 9 W/mK.

Examples of measurement of thermal conductivity are as follows.

The elastic sheet may be prepared into a specimen with a size of width*length=2 cm*2 cm, which may be measured with respect to the horizontal thermal conductivity according to ISO22007-2 by using TPS2200 (Manufacturer: Hot Disk AB) and the vertical thermal conductivity according to ASTM5470 by using TIM-1300 (Manufacturer: Analysis Tech Inc.).

### Thickness of Elastic Sheet

A thickness of the elastic sheet may be, e.g., about 100 μm to about 800 μm, about 100 μm to about 600 μm, or about 120 μm to about 200 μm. Maintaining the elastic sheet within these thickness ranges may help ensure that the elastic sheet may sufficiently relieve stress due to pressure and stress due to thickness changes during charging and discharging and may exhibit excellent restoring force. The thickness of the elastic sheet can be measured using a thickness gauge.

### Structure of Elastic Sheet

The elastic sheet may have a single-layer or multi-layer structure. In an implementation, the elastic sheet has a multi-layer structure and each layer may be made of the same material or a different material, and each sheet may be designed to have a different modulus. The elastic sheet may further include a protective film or coating layer on one surface.

### Method of Manufacturing Elastic Sheet

The elastic sheet may be manufactured through a series of processes that involve polymerizing a monomer mixture constituting the (meth)acrylate copolymer in the presence of an initiator to prepare the (meth)acrylate copolymer; mixing the (meth)acrylate copolymer with aluminum hydroxide and inorganic nanotubes, and optionally adding the additives to prepare an elastic sheet composition; coating the elastic sheet composition on a release film and irradiating it with light or heat; and removing the elastic sheet formed on the release film.

### (All-Solid-State Battery)

In an implementation, an all-solid-state battery may include the elastic sheet; and electrode assembly, wherein the electrode assembly includes a positive electrode; a negative electrode; and a solid electrolyte layer between the positive electrode and the negative electrode, and the elastic sheet is outside at least one of the positive electrode and the negative electrode.

The elastic sheet may be on the outermost layer of the electrode assembly, or, in a structure in which two or more electrode assemblies are stacked, maybe on the outermost layer or inside the assembly. Considering that the thickness of the negative electrode may change significantly during charging and discharging due to dendrite formation, etc., the elastic sheet may play a role in buffering problems caused by changes in thickness by being on the outside of the negative electrode, e.g., on the opposite surface of the surface where the solid electrolyte layer may be in contact with the negative electrode. In addition, the elastic sheet may prevent deterioration by reacting with lithium by being on the outside of the positive electrode or negative electrode, thereby increasing the coulombic efficiency of the battery.

Hereinafter, an all-solid-state battery according to some embodiments will be described in detail.

The all-solid-state battery may also be expressed as an all-solid-state rechargeable battery or an all-solid-state rechargeable lithium battery.

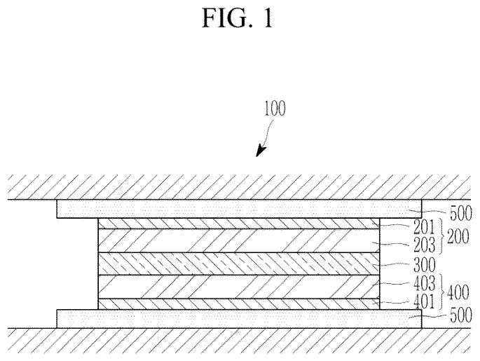

FIG. 1 is a cross-sectional view of an all-solid-state battery according to some embodiments. Referring to FIG. 1, the all-solid-state battery 100 may have a structure in which an electrode assembly including a negative electrode 400, including a negative current collector 401 and a negative electrode active material layer 403, a solid electrolyte layer 300, and a positive electrode 200, including a positive electrode active material layer 203 and a positive current collector 201, are stacked and may be inserted into a case such as a pouch. The all-solid-state battery 100 may further include at least one elastic layer 500 on the outside of at least either one of the positive electrode 200 or the negative electrode 400. In an implementation, as illustrated in FIG. 1, one electrode assembly may include a negative electrode 400, a solid electrolyte layer 300, and a positive electrode 200 or more electrode assemblies may be stacked to manufacture an all-solid-state battery.

An all-solid-state battery according to some embodiments may be manufactured by preparing a laminate by sequentially stacking a positive electrode, a solid electrolyte, and a negative electrode, and pressing the laminate.

The pressing may be performed at a temperature of, e.g., about 25° C. to about 90° C., and may be performed at a pressure of less than or equal to, e.g., about 550 MPa, or less than or equal to about 500 MPa, e.g., about 400 MPa to about 500 MPa. The pressing may be, e.g., isostatic press, roll press or plate press.

The all-solid-state battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state battery may be, e.g., a coin type, a button type, a sheet type, a stack type, a cylindrical shape, a flat type, and the like. In an implementation, the all-solid-state battery may also be applied to medium to large-sized batteries used in electric vehicles, etc. In an implementation, the all-solid-state battery may also be used in a hybrid vehicle such as a plug-in hybrid electric vehicle (PHEV). In an implementation, it may be applied to an energy storage system (ESS) that requires large amounts of power storage, and may also be applied to electric bicycles or power tools.

### Positive Electrode Active Material

The positive electrode active material may be a compound capable of reversible intercalation and deintercalation of lithium (lithiated intercalation compound). In an implementation, one or more types of complex oxides of lithium and a metal, e.g., cobalt, manganese, nickel, and a combination thereof may be used.

The complex oxide may be a lithium transition metal complex oxide, and, e.g., may include a lithium nickel oxide, a lithium cobalt oxide, a lithium manganese oxide, a lithium iron phosphate compound, a cobalt-free lithium nickel-manganese oxide, or a combination thereof.

In an implementation, a compound represented by any of the chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A may be, e.g., Ni, Co, Mn, or a combination thereof; X may be, e.g., Al, Ni, Co, Mn, Cr, Fe, Mg, Sr, V, rare earth element, or a combination thereof; D may be, e.g., O, F, S, P, or a combination thereof; G may be, e.g., Al, Cr, Mn, Fe, Mg, La, Ce, Sr, V, or a combination thereof; and L¹ may be, e.g., Mn, Al, or a combination thereof.

In an implementation, the positive electrode active material may be a high nickel positive electrode active material that has a nickel content of greater than or equal to, e.g., about 80 mol %, greater than or equal to about 85 mol %, greater than or equal to about 90 mol %, greater than or equal to about 91 mol %, or greater than or equal to about 94 mol % and less than or equal to about 99 mol %, based on total mol % of metals excluding lithium in the lithium transition metal complex oxide. The high-nickel positive electrode active materials can achieve high capacity and can be applied to high-capacity, high-energy-density lithium rechargeable batteries.

The positive electrode active material may include, e.g., lithium nickel oxide represented by Chemical Formula 11, lithium cobalt oxide represented by Chemical Formula 12, a lithium iron phosphate compound represented by Chemical Formula 13, and cobalt-free lithium nickel manganese oxide represented by Chemical Formula 14, or a combination thereof.

Liₐ₁Niₓ₁M¹_{y1}M²_{z1}O_{2-b1}X_{b1} [Chemical Formula 11]

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be, e.g., Al, B, Ba, Ca, Ce, Co, Cr, Cu, Fe, Mg, Mn, Mo, Nb, Si, Sn, Sr, Ti, V, W, or Zr, and X may each independently be, e.g., F, P, or S.

In Chemical Formula 1, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³_{y2}O_{2-b2}X_{b2} [Chemical Formula 12]

In Chemical Formula 12, 0.9≤a2≤1.8, 0.7≤x2≤1, 0≤y2≤0.3, 0.9≤x2+y2≤1.1, and 0≤b2≤0.1, M³ may be, e.g., Al, B, Ba, Ca, Ce, Cr, Cu, Fe, Mg, Mn, Mo, Ni, Se, Si, Sn, Sr, Ti, V, W, Y, Zn, or Zr, and X may be, e.g., F, P, or S.

Liₐ₃Feₓ₃M⁴_{y3}PO_{4-b3}X_{b3} [Chemical Formula 13]

In Chemical Formula 13, 0.9≤a3≤1.8, 0.6≤x3≤1, 0≤y3≤0.4, and 0≤b3≤0.1, M⁴ may be, e.g., Al, B, Ba, Ca, Ce, Co, Cr, Cu, Mg, Mn, Mo, Ni, Se, Si, Sn, Sr, Ti, V, W, Y, Zn, or Zr, and X may be, e.g., F, P, or S.

Liₐ₄Niₓ₄Mn_{y4}M⁵_{z4}O_{2-b4}X_{b4} [Chemical Formula 14]

In Chemical Formula 14, 0.9≤a2≤1.8, 0.8≤x4<1,0<y4≤0.2, 0≤z4≤0.2, 0.9≤x4+y4+z4≤1.1, and 0≤b4≤0.1, M⁵ may be, e.g., Al, B, Ba, Ca, Ce, Cr, Fe, Mg, Mo, Nb, Si, Sn, Sr, Ti, V, W, or Zr, and X may be, e.g., F, P, or S.

The average particle diameter (D50) of the positive electrode active material may be about 1 μm to about 25 μm, e.g., about 3 μm to about 25 μm, about 1 μm to about 20 μm, about 1 μm to about 18 μm, about 3 μm to about 15 μm, or about 5 μm to about 15 μm. In an implementation, the positive electrode active material may include small particles having an average particle diameter (D50) of about 1 μm to about 9 μm and large particles having an average particle diameter (D50) of about 10 μm to about 25 μm. Maintaining the positive electrode active material in this particle size range may help the positive electrode active material harmoniously mix with other components within the positive electrode active material layer and may help the positive electrode active material achieve high capacity and high energy density. Herein, the average particle diameter may be obtained by selecting about 20 particles at random in the scanning electron microscope image of the positive electrode active material, measuring the particle diameter (e.g., diameter, long axis, or length of the long axis) to obtain the particle size distribution, and taking the diameter (D50) of particles with a cumulative volume of 50 volume % as the average particle diameter in the particle size distribution.

The positive electrode active material may be in the form of secondary particles made by agglomerating a plurality of primary particles, or the positive electrode active material may be in the form of single particles. In an implementation, the positive electrode active material may have a spherical or close to spherical shape, or may have a polyhedral or irregular shape.

In an implementation, the positive electrode active material may include a buffer layer on the particle surface. The buffer layer may be expressed as a coating layer, a protective layer, etc., and may play a role in lowering the interfacial resistance between the positive electrode active material and the sulfide solid electrolyte particles. In an implementation, the buffer layer may include lithium-metal-oxide, wherein the metal may be, e.g., Al, B, Ca, Ce, Cr, Fe, Mg, Mo, Nb, Si, Sn, Sr, Ta, V, W, or Zr. The lithium-metal-oxide is excellent for improving the performance of the positive electrode active material by facilitating the movement of lithium ions and electronic conduction, while lowering the interfacial resistance between the positive electrode active material and solid electrolyte particles.

### Positive Electrode

A positive electrode for an all-solid-state battery may include a current collector and a positive electrode active material layer on the current collector, and the positive electrode active material layer may include a positive electrode active material and may optionally include a solid electrolyte, a binder, or a conductive material.

In an implementation, the positive electrode may further include an additive that can function as a sacrificial positive electrode.

A content of the positive electrode active material may be about 90 wt % to about 99.5 wt %, based on a total weight of the positive electrode active material layer and each content of the binder and the conductive material may be about 0.5 wt % to about 5 wt %, based on the total weight of the positive electrode active material layer.

The binder may help improve binding properties of positive electrode active material particles with one another and with a current collector. Examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon.

The conductive material may be included to help provide electrode conductivity and any suitable electrically conductive material may be used as a conductive material unless it causes a chemical change. Examples of the conductive material may include a carbon material such as natural graphite, artificial graphite, carbon black, acetylene black, ketjen black, a carbon fiber, a carbon nanofiber, a carbon nanotube, or the like; a metal material of a metal powder or a metal fiber including copper, nickel, aluminum, silver, or the like; a conductive polymer such as a polyphenylene derivative; or a mixture thereof.

In an implementation, the positive electrode active material layer may include a solid electrolyte. The solid electrolyte may include, e.g., a sulfide solid electrolyte, an oxide solid electrolyte, a halide solid electrolyte, or a combination thereof, and detailed descriptions thereof will be provided later in the solid electrolyte layer section.

Based on a total weight of the positive electrode active material layer, the solid electrolyte may be included in an amount of, e.g., about 0.1 wt % to about 35 wt %, e.g., about 1 wt % to about 35 wt %, about 5 wt % to about 30 wt %, about 8 wt % to about 25 wt %, or about 10 wt % to about 20 wt %.

In the positive electrode active material layer, based on a total weight of the positive electrode active material and the solid electrolyte, e.g., about 65 wt % to about 99 wt % of the positive electrode active material and about 1 wt % to about 35 wt % of the solid electrolyte may be included, e.g., about 80 wt % to about 90 wt % of the positive electrode active material and about 10 wt % to about 20 wt % of the solid electrolyte. In an implementation, the solid electrolyte may be included in the positive electrode within the above ranges, and the efficiency and cycle-life characteristics of the all-solid-state secondary battery may thereby be improved without reducing the capacity.

The current collector may include Al.

### Negative Electrode Active Material

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon negative electrode active material. The crystalline carbon may be irregular, or sheet, flake, spherical, or fiber shaped natural graphite or artificial graphite. The amorphous carbon may be, e.g., a soft carbon, a hard carbon, a mesophase pitch carbonization product, calcined coke, or the like.

The lithium metal alloy may include an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include silicon, a silicon-carbon composite, SiOₓ (0<x<2), a Si-Q alloy (wherein Q may be, e.g., an alkali metal, an alkaline-earth metal, a Group 13 element, a Group 14 element (excluding Si), a Group 15 element, a Group 16 element, a transition metal, a rare earth element, and a combination thereof), or a combination thereof. The Sn negative electrode active material may be, e.g., Sn, SnO₂, a Sn alloy, or a combination thereof.

The silicon-carbon composite may be a composite of silicon and amorphous carbon. In an implementation, the silicon-carbon composite may be in the form of silicon particles and amorphous carbon coated on the surface of the silicon particles. In an implementation, it may include a secondary particle (core) in which silicon primary particles are assembled and an amorphous carbon coating layer (shell) on the surface of the secondary particle. The amorphous carbon may also be present between the silicon primary particles, e.g., the silicon primary particles may be coated with amorphous carbon. The secondary particles may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on the surface of the core.

The Si negative electrode active material or Sn negative electrode active material may be mixed with the carbon negative electrode active material.

### Negative Electrode

In an implementation, a negative electrode for an all-solid-state battery may include a current collector and a negative electrode active material layer on the current collector. The negative electrode active material layer may include a negative electrode active material and may further include a binder, a conductive material, or a solid electrolyte.

In an implementation, the negative electrode active material layer may include, based on a total weight of the negative electrode active material, e.g., about 90 wt % to about 99 wt % of the negative electrode active material, about 0.5 wt % to about 5 wt % of the binder, and about 0 wt % to about 5 wt % of the conductive material.

The binder may help adhere the negative electrode active material particles to each other and to help adhere the negative electrode active material to the current collector. The binder may be, e.g., a non-aqueous binder, an aqueous binder, a dry binder, or a combination thereof.

The non-aqueous binder may include, e.g., polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber, a (meth)acrylated styrene-butadiene rubber, a (meth)acrylonitrile-butadiene rubber, a (meth)acrylic rubber, butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

In an implementation, an aqueous binder may be used as the negative electrode binder and a cellulose compound capable of imparting viscosity may be further included. As the cellulose compound, e.g., carboxymethyl cellulose, hydroxypropyl methyl cellulose, methyl cellulose, or alkali metal salts thereof may be mixed and used. The alkali metal may be, e.g., Na, K, or Li.

The dry binder may be a polymer material capable of becoming fiber, and may be, e.g., polytetrafluoroethylene, polyvinylidene fluoride, a polyvinylidene fluoride-hexafluoropropylene copolymer, polyethylene oxide, or a combination thereof.

The conductive material may be included to help provide electrode conductivity and any suitable electrically conductive material may be used as a conductive material unless it causes a chemical change. Examples of the conductive material include a carbon material such as natural graphite, artificial graphite, carbon black, acetylene black, ketjen black, a carbon fiber, a carbon nanofiber, a carbon nanotube, and the like; a metal material of a metal powder or a metal fiber including copper, nickel, aluminum silver, or the like; a conductive polymer such as a polyphenylene derivative; or a mixture thereof.

The negative electrode current collector may include, e.g., a copper foil, a nickel foil, a stainless steel foil, a titanium foil, a nickel foam, a copper foam, a polymer substrate coated with a conductive metal, or a combination thereof.

### Precipitation-Type Negative Electrode

In an implementation, the negative electrode for an all-solid-state battery may be a precipitation-type negative electrode. The precipitation-type negative electrode may not include a negative electrode active material during battery assembly, but refers to a negative electrode in which lithium metal, etc. may be precipitated during battery charging, thereby serving as a negative electrode active material.

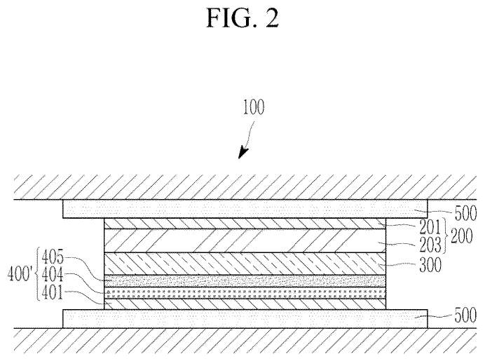

FIG. 2 is a schematic cross-sectional view of an all-solid-state battery including a precipitation-type negative electrode. Referring to FIG. 2, the precipitation-type negative electrode 400′ may include a current collector 401 and a negative electrode coating layer 405 on the current collector. In an all-solid-state battery having such a precipitation-type negative electrode 400′, initial charging may begin in the absence of a negative electrode active material, and during charging, high-density lithium metal may be precipitated between the current collector 401 and the negative electrode coating layer 405 to form a lithium metal layer 404, which may serve as a negative electrode active material. In an implementation, in an all-solid-state battery that has been charged at least once, the precipitation-type negative electrode 400′ may include a current collector 401, a lithium metal layer 404 on the current collector 401, and a negative electrode coating layer 405 on the metal layer 404. The lithium metal layer 404 may be referred to as a layer in which lithium metal, etc. may be precipitated during the charging process of the battery, and may be referred to as a metal layer or negative electrode active material layer.

The cathode coating layer 405 may include metal and/or carbon material that acts as a catalyst.

The metal may be a lithiophilic metal and may include, e.g., gold, platinum, palladium, silicon, silver, aluminum, bismuth, tin, zinc, or a combination thereof, and may be composed of one of these or various types of alloys. An average particle diameter (D50) of the metal may be less than or equal to about 4 μm, e.g., about 10 nm to about 4 μm, about 10 nm to about 2 μm, or about 10 nm to about 1 μm.

The carbon material may be, e.g., crystalline carbon, non-graphitic carbon, or a combination thereof. In an implementation, the crystalline carbon may be, e.g., natural graphite, artificial graphite, mesophase carbon microbeads, or a combination thereof. The non-graphitic carbon may be, e.g., carbon black, activated carbon, acetylene black, denka black, ketjen black, furnace black, graphene, or a combination thereof.

In an implementation, the negative electrode coating layer 405 may include both the metal and the carbon material, a mixing ratio of the metal and the carbon material may be, e.g., a weight ratio of about 1:10 to about 2:1, about 1:10 to about 2:1, about 5:1 to about 1:1, or about 4:1 to about 2:1. In this case, precipitation of lithium metal may be effectively promoted and the characteristics of the all-solid-state battery can be improved. In an implementation, the negative electrode coating layer 405 may include a carbon material on which a catalyst metal may be supported, or may include a mixture of metal particles and carbon material particles.

The negative electrode coating layer 405 may further include a binder, and the binder may be, e.g., a conductive binder. In an implementation, the negative electrode coating layer 405 may further include general additives, e.g., a filler, a dispersant, an ion conductive material, and the like.

A thickness of the negative electrode coating layer 405 may be, e.g., about 1 μm to about 20 μm, about 2 μm to about 10 μm, or about 3 μm to about 7 μm. In an implementation, the thickness of the negative electrode coating layer 405 may be, e.g., about 50% or less, about 20% or less, or about 5% or less of the thickness of the positive electrode active material layer. If the thickness of the negative electrode coating layer 405 were to be too thin, it could be collapsed by the lithium metal layer 404, and if the thickness of the negative electrode coating layer 405 were to be too thick, the density of the all-solid-state battery could decrease and internal resistance may increase.

The precipitation-type negative electrode 400′ may further include a thin film, e.g., on the surface of the current collector, e.g., between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, and the like, which may be used alone or an alloy of more than one. The thin film may further help planarize a precipitation shape of the lithium metal layer 404 and help much improve characteristics of the all-solid-state battery. The thin film may be formed, e.g., in a vacuum deposition method, a sputtering method, a plating method, or the like. The thin film may have, e.g., a thickness of about 1 nm to about 800 nm, or about 100 nm to about 500 nm.

The lithium metal layer 404 may include a lithium metal or a lithium alloy. The lithium alloy may be, e.g., a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be, e.g., about 1 μm to about 500 μm, about 1 μm to about 200 μm, about 1 μm to about 100 μm, or about 1 μm to about 50 μm. If the thickness of the lithium metal layer 404 were to be too thin, it may be difficult to perform the role of a lithium storage, and if it were to be too thick, the battery volume may increase and performance may deteriorate.

In an implementation using such a precipitation-type negative electrode, the negative electrode coating layer 405 may serve to protect the lithium metal layer 404 and suppress the precipitation growth of lithium dendrite. In an implementation, short circuit and capacity degradation of the all-solid-state battery may be suppressed and cycle-life characteristics can be improved.

### Solid Electrolyte Layer

The solid electrolyte layer may include a solid electrolyte.

The solid electrolyte may be a type of inorganic solid electrolyte, and may include, e.g., a sulfide solid electrolyte, an oxide solid electrolyte, a halide solid electrolyte, or a combination thereof.

### Sulfide Solid Electrolyte

The sulfide solid electrolyte may include, e.g., Li₂S—P₂S₅, Li₂S—P₂S₅—LiX (wherein X may be a halogen element, e.g. I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are an integer, respectively, and Z may be, e.g., Ge, Zn, or Ga), Li₂S—GeS₂, Li₂S—SiS₂—Li₃PO₄, Li₃S—SiS₂—LiₚMO_{q} (wherein p and q are integers, and M may be, e.g., P, Si, Ge, B, Al, Ga, or In), or a combination thereof.

The sulfide solid electrolyte may be obtained by, e.g., mixing Li₂S and P₂S₅ in a molar ratio of about 50:50 to about 90:10 or about 50:50 to about 80:20 and optionally, performing a heat treatment. Within the above mixing ratio ranges, a sulfide solid electrolyte having excellent ionic conductivity may be prepared. The ionic conductivity may be further improved by adding SiS₂, GeS₂, B₂S₃, or the like as other components thereto.

Mechanical milling or a solution method may be applied as a mixing method of sulfur-containing raw materials for preparing a sulfide solid electrolyte. The mechanical milling may make starting materials into particulates by putting the starting materials in a ball mill reactor and vigorously stirring them. The solution method may be performed by mixing the starting materials in a solvent to obtain a solid electrolyte as a precipitate. In addition, in the case of a heat treatment after mixing, crystals of the solid electrolyte may be more robust and ionic conductivity may be improved. In an implementation, the sulfide solid electrolyte may be prepared by mixing sulfur-containing raw materials and performing a heat treatment two or more times. In this case, a sulfide solid electrolyte having high ionic conductivity and robustness may be prepared.

The sulfide solid electrolyte particles according to some embodiments, e.g., may be prepared through a first heat treatment of mixing sulfur-containing raw materials and firing, e.g., at about 120° C. to about 350° C. and a second heat treatment of mixing the resultant of the first heat treatment and firing the same, e.g., at about 350° C. to about 800° C. The first heat treatment and the second heat treatment may be performed under an inert gas or nitrogen atmosphere, respectively. The first heat treatment may be performed, e.g., for about 1 hour to about 10 hours, and the second heat treatment may be performed, e.g., for about 5 hours to about 20 hours. Small raw materials may be milled through the first heat treatment, and a final solid electrolyte can be synthesized through the second heat treatment. Through such two or more heat treatments, a sulfide solid electrolyte having high ionic conductivity and high performance can be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide solid electrolyte particle may have high ionic conductivity close to the range of about 10⁻⁴ to about 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

In an implementation, the argyrodite-type sulfide solid electrolyte particles may include a compound represented by Chemical Formula 21.

(LiₐM¹₆M²_{c})(P_{d}M³ₑ)(S_{f}M⁴_{g})Xₕ [Chemical Formula 21]

In Chemical Formula 21, 4≤a≤8, M¹ may be, e.g., Mg, Cu, Ag, or a combination thereof, 0≤b<0.5, M² may be, e.g., Na, K, or a combination thereof, 0≤c<0.5, M³ may be, e.g., Sn, Zn, Si, Sb, Ge, or a combination thereof, 0<d<4, 0≤e<1, M⁴ may be, e.g., O, SOₙ, or a combination thereof, 1.5≤n≤5, 3≤f≤12, 0≤g<2, X may be, e.g., F, Cl, Br, I, or a combination thereof, and 0≤h≤2.

In an implementation, in Chemical Formula 21, a halide element (X) may be necessarily included, and in this case, it may be expressed as 0<h≤2. In an implementation, the M¹ element may be necessarily included in Chemical Formula 21, and in this case, it may be expressed as 0≤b<0.5. In Chemical Formula 21, M³ may be understood as an element substituted for P and may be 0<<1. In Chemical Formula 21, M⁴ may be substituted for S and, e.g., may be 0<g<2, and f, a ratio of S, may be, e.g., 3≤f<7. In an implementation, M⁴ may be SOₙ, SOₙ may be, e.g., S₄O₆, S₃O₆, S₂O₃, S₂O₄, S₂O₅, S₂O₆, S₂O₇, S₂O₈, SO₄, or SO₅, and, e.g., may be SO₄.

In an implementation, in Chemical Formula 21, a+b+c+h=7, d+e=1, and f+g+h=6.

In an implementation, the argyrodite-type sulfide solid electrolyte particles may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025}) Cl_{1.25}, Li_{5.75}P(S_{4.725}(SO₄)_{0.025})Cl_{1.25}, or a combination thereof.

The argyrodite-type sulfide solid electrolyte may be prepared, e.g., by mixing lithium sulfide and phosphorus sulfide, and optionally lithium halide. Heat treatment may be performed after mixing them. The heat treatment may include, e.g., two or more heat treatment steps. The method of preparing the argyrodite-type sulfide solid electrolyte may include, e.g., a first heat treatment in which raw materials are mixed and fired, e.g., at about 120° C. to about 350° C., and a second heat treatment in which the resultant of the first heat treatment is mixed again and fired, e.g., at about 350° C. to about 800° C.

An average particle diameter (D50) of the sulfide solid electrolyte particles may be, e.g., about 0.1 μm to about 5.0 μm or about 0.1 μm to about 3.0 μm, and may be small particles of, e.g., about 0.1 μm to about 1.9 μm or large particles of, e.g., about 2.0 μm to about 5.0 μm. The sulfide solid electrolyte particles may be a mixture of small particles having an average particle diameter of, e.g., about 0.1 μm to about 1.9 μm and large particles having an average particle diameter of, e.g., about 2.0 μm to about 5.0 μm. The average particle diameter of the sulfide solid electrolyte particles may be measured using an electron microscope image, and, e.g., a particle size distribution may be obtained by measuring the size (diameter or length of the long axis) of about 20 particles in a scanning electron microscope image, and D50 may be calculated therefrom.

### Oxide Solid Electrolyte

The oxide solid electrolyte may include, e.g., Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN—PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSiₓP_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M=Te, Nb, or Zr; x is an integer of 1 to 10), or a mixture thereof.

### Halide Solid Electrolyte

The solid electrolyte layer may further include, e.g., a halide solid electrolyte. The halide solid electrolyte may include a halogen element as a main component, meaning that a ratio of the halide element to all elements constituting the solid electrolyte may be, e.g., about 50 mol % or more, about 70 mol % or more, about 90 mol % or more, or about 100 mol %. In an implementation, the halide solid electrolyte may not include sulfur element.

The halide solid electrolyte may include, e.g., a lithium element, a metal element other than lithium, and a halogen element. The metal element other than lithium may include, e.g., Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be, e.g., F, Cl, Br, I, or a combination thereof, and, e.g., it may be Cl, Br, or a combination thereof. The halide solid electrolyte may be, e.g., represented by LiₐM₁X₆ (M may be Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X may be F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

### Binder

The solid electrolyte layer may further include a binder. The binder may include, e.g., a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethyleneoxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The binder may be included in an amount of about 0.1 wt % to about 3 wt %, e.g., about 0.5 wt % to about 2 wt %, about 0.5 wt % to about 1.5 wt %, based on a total weight of the solid electrolyte layer. Maintaining the binder within the above ranges may help ensure that the components in the solid electrolyte layer may be well combined without reducing the ionic conductivity of the solid electrolyte, thereby improving durability and reliability of the battery.

### Other Components

In an implementation, the solid electrolyte layer may further include an alkali metal salt, and/or an ionic liquid, or a conductive polymer.

The alkali metal salt may be, e.g., a lithium salt. A concentration of the lithium salt in the solid electrolyte layer may be greater than or equal to about 1 M, e.g., about 1 M to about 4 M. In an implementation, the lithium salt may improve ionic conductivity by improving lithium ion mobility of the solid electrolyte layer.

The lithium salt may include, e.g., LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro (oxalato)borate (LiDFOB), lithium difluorobis(oxalato)phosphate (LiDFBP), lithium bis(trifluoromethanesulfonyl)imide (LiTFSI), lithium bis(fluoro)sulfonyl)imide (LiFSI), lithium bis(pentafluoroethanesulfonyl)imide (LiBETI), lithium trifluoromethane sulfonate, lithium tetrafluoroethane sulfonate, or a combination thereof.

In an implementation, the lithium salt may be an imide lithium salt, e.g., LiTFSI, LIFSI, LiBETI, or a combination thereof. The imide lithium salt may help maintain or improve ionic conductivity by helping appropriately maintaining chemical reactivity with the ionic liquid.

The ionic liquid may have a melting point below room temperature, so it may be in a liquid state at room temperature and may refer to a salt or room temperature molten salt composed of ions alone.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, triazolium, and a mixture thereof, and an, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, e.g., N-methyl-N-propylpyrrolidinium bis(trifluoromethanesulfonyl) imide, N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be, e.g., about 0.1:99.9 to about 90:10, e.g., about 10:90 to about 90:10, about 20:80 to about 90:10, about 30:70 to about 90:10, about 40:60 to about 90:10, or about 50:50 to about 90:10. Maintaining the solid electrolyte layer in the above ranges may help maintain or improve ionic conductivity by improving the electrochemical contact area with the electrode. In an implementation, the energy density, discharge capacity, rate capability, etc. of the all-solid-state rechargeable battery may be improved.

The rechargeable lithium battery according to some embodiments may be applied to automobiles, mobile phones, or various types of electrical devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Preparation Example: Preparation of Acrylate Copolymer

An acrylate copolymer (Mw=1,300,000 g/mol, Mw/Mn=1.7) was prepared by mixing 2-ethylhexyl acrylate (2-EHA, Manufacturer: LG Chem), isobornyl acrylate (IBOA, Manufacturer: Osaka Organic Chemical Industry Ltd.), and 4-hydroxybutyl acrylate (4-HBA, Manufacturer: Osaka Organic Chemical Industry Ltd.) in a weight ratio of 50:15:35 to obtain a monomer mixture, adding 0.35 parts by weight of 1,2-diphenyl-2,2-dimethoxyethanone (Tradename: igacure651, Manufacturer: Ciba Inc.) as an initiator based on 100 parts by weight of the monomer mixture thereto, and then, polymerizing a portion of the monomer mixture by irradiating ultraviolet rays thereinto with a lamp with UV intensity of 10 mw/cm² after exchanging oxygen dissolved in the reactor with nitrogen gas.

### (Elastic Sheet in Form of Foam)

### Example 1

### (1) Manufacture of Elastic Sheet

An elastic sheet composition was prepared by mixing 0.1 parts by weight of 1,6-hexanediol diacrylate as a crosslinking agent, 200 parts by weight of aluminum hydroxide, 0.1 parts by weight of boehmite nanotubes (Boehmite, an aspect ratio: 40, Manufacturer: Aramis) as an inorganic nanotube, 10 parts by weight of aluminum diethylphosphinate (ADP, OMP-900; manufacturer: Universal ChemTech. Co., Ltd.) as a flame retardant, 0.5 parts by weight of acrylonitrile microspheres (tradename: Expancel 920DET40 d25, D50: 40 μm, manufacturer: Nouryon) as a thermally expanded polymer microsphere, and 1.5 parts by weight of glass bubbles (tradename: K-1, manufacturer: 3M) as a glass microsphere based on 100 parts by weight of the acrylate copolymer of the preparation example.

The elastic sheet composition was applied on a polyethylene terephthalate (PET) film, which is a releasing film, and then, irradiated by ultraviolet rays at a light dose of 2000 mJ/cm² to form an elastic sheet adhered to the releasing film. Subsequently, the releasing film was removed to obtain the elastic sheet.

### (2) Manufacture of Positive Electrode

85 wt % of a LiNi_{0.8}C_{0.15}Mn_{0.05}O₂ positive electrode active material, 13.5 wt % of a lithium argyrodite-type solid electrolyte Li₆PS₅Cl, 1.0 wt % of a polyvinylidene fluoride binder, and 0.5 wt % of a carbon nanotube conductive material were mixed in an N-methyl pyrrolidone solvent to prepare a positive electrode composition.

The prepared positive electrode composition was coated on an aluminum positive electrode current collector using a bar coater, dried, and rolled to manufacture a positive electrode.

### (3) Manufacture of Solid Electrolyte Layer

An acrylic binder (SX-A334, Zeon Chemicals L.P.) was dissolved in an isobutyl isobutyrate (IBIB) solvent to obtain a binder solution, an argyrodite-type solid electrolyte of Li₆PS₅Cl (D50=3 μm) was added thereto and then, stirred with a Thinky mixer to secure appropriate viscosity, and 2 mm zirconia balls were added thereto and then, stirred again with the Thinky mixer to prepare slurry. In the prepared slurry, a content of the solid electrolyte was 98.5 wt %, and a content of the binder was 1.5 wt %.

The slurry was applied on a polyethylene terephthalate (PET) film, which is a releasing film, with a bar coater and then, dried at room temperature (25° C.), and the releasing film was removed to obtain a solid electrolyte layer.

### (4) Manufacture of Negative Electrode

Carbon black with a primary particle diameter (D50) of about 30 nm and silver (Ag) with an average particle diameter (D50) of about 60 nm were mixed at a weight ratio of 3:1, and 0.25 g of this mixture was added to 2 g of N-methyl pyrrolidone solution including 7 wt % of polyvinylidene fluoride binder and mixed to prepare a negative electrode active material layer composition.

The negative electrode active material layer composition was coated on a nickel foil current collector using a bar coater and dried in vacuum to manufacture a negative electrode.

(5) Manufacture of all-Solid-State Battery Cell

After sequentially stacking the manufactured positive electrode, solid electrolyte, and negative electrode, the elastic sheet was stacked on the negative electrode. Subsequently, on the elastic sheet, the negative electrode, solid electrolyte layer, and positive electrode were sequentially once more stacked to manufacture an assembly of positive electrode/solid electrolyte/negative electrode/elastic sheet/negative electrode/solid electrolyte/positive electrode in order.

The assembly was housed in a laminate film and then, isostatically pressed under a pressure of 500 MPa at 80° C. to manufacture an all-solid-state battery cell.

In the pressurized state, the positive electrode active material layer had a thickness of about 100 μm, the negative electrode coating layer had a thickness of about 7 μm, the solid electrolyte layer had a thickness of about 60 μm, and the elastic sheet had a thickness of about 120 μm.

### Example 2

An elastic sheet and an all-solid-state battery cell were manufactured in the same manner as in Example 1 except that 100 parts by weight of the aluminum hydroxide was used based on 100 parts by weight of the acrylate copolymer according to the preparation example.

### Example 3

An elastic sheet and an all-solid-state battery cell were manufactured in the same manner as in Example 1 except that based on 100 parts by weight of the acrylate copolymer according to the preparation example, 100 parts by weight of the aluminum hydroxide was used; but the flame retardant was not used.

### Comparative Example 1

An elastic sheet and an all-solid-state battery cell were manufactured in the same manner as in Example 1 except that based on 100 parts by weight of the acrylate copolymer according to the preparation example, 100 parts by weight of aluminum hydroxide was used; but the inorganic nanotube and the flame retardant were not used.

### Comparative Example 2

An elastic sheet and an all-solid-state battery cell were manufactured in the same manner as in Example 1 except that the aluminum hydroxide, the inorganic nanotube, and the flame retardant were not used.

### Evaluation Example 1: Evaluation of Mechanical Properties of Elastic Sheet

Each of the elastic sheets of Examples 1 to 3 and Comparative Examples 1 and 2 was cut to prepare a specimen with a size of width*length=2 cm*2 cm, which was compressed at a compression ratio of 0.6 mm/min (10 μm/sec) by using a compression tester with a spherical jig having a diameter of 10 mm to evaluate compressive strength, a stress relief rate, and a recovery rate. The evaluation results are shown in Table 1.

### (1) Compressive Strength

Each of the elastic sheet specimens was measured at a point of being compressed to 60% of an initial thickness with respect to CFD 40% according to ASTM D3574 by using UTM (manufacturer: Shimadzu Scientific Korea Corp.).

### (2) Stress Relief Rate

Each of the elastic sheet specimen was measured at a point of being compressed to 40% of its initial thickness with respect to initial stress. In addition, the elastic sheet specimen was measured with respect to stress 60 seconds later from the point of being compressed to 40% of its initial thickness. Herein, the stress at each point was measured by using TA (Texture Analyzer, Manufacturer: Stable Micro Systems).

A stress relief rate was calculated according to Equation 1.

Stress relief rate=100*(Stress after 60 seconds when compressed to 40% of initial thickness)/(Initial stress when compressed to 40% of initial thickness) [Equation 1]

### (3) Recovery Rate

Each of the elastic sheet specimens was measured at a point of being compressed to 60% of its initial thickness with respect to initial stress. In addition, the elastic sheet specimen compressed to 40% of its initial thickness was measured at a point of being recovered to 60% of the initial thickness with respect to stress. Herein, the stress at each point was measured by using TA (Texture Analyzer, manufacturer: Stable Micro Systems).

A recovery rate was calculated according to Equation 2.

Recovery rate=100*(Stress upon restoration to 60% of the initial thickness after compression to 40% of the initial thickness)/(Initial stress after compression to 60% of the initial thickness) [Equation 2]

### Evaluation Example 2: Evaluation of Thermal Properties of Elastic Sheet

Each of the elastic sheets of Examples 1 to 3 and Comparative Examples 1 and 2 was cut to prepare a specimen with a size of width*length=2 cm*2 cm to evaluate thermal conductivity and flame retardancy grades. The evaluation results are shown in Table 1.

### (1) Thermal Conductivity

Each of the elastic sheet specimens was measured with respect to thermal conductivity in a horizontal direction according to ISO22007-2 by using TPS2200 (manufacturer: Hot Disk AB) and thermal conductivity in a vertical direction according to ASTM5470 by using TIM-1300 (manufacturer: Analysis Tech, Inc.).

### (2) Flame Retardancy Grade

Each of the elastic sheet specimens was combustion-tested according to a VTM test described in UL standard (UL94 a combustion test method for plastic materials for device parts).

### Evaluation Example 3: Evaluation of Electrochemical Characteristics of All-Solid-State Battery Cell

Each of the all-solid-state battery cells of Examples 1 to 3 and Comparative Examples 1 and 2 was evaluated with respect to coulombic efficiency and cycle-life in the following methods. The evaluation results are shown in Table 1.

### (1) Coulombic Efficiency

Each of the all-solid-state battery cells of Examples 1 to 3 and Comparative Examples 1 and 2 was charged to an upper limit voltage of 4.25 V at a constant current of 0.1 C and discharged to a cut-off voltage of 2.5 V at 0.1 C at 45° C. and then, measured with respect to initial charge and discharge.

Coulombic efficiency=100*(initial discharge capacity/initial charge capacity) [Equation 3]

### (2) Cycle-Life

After measuring the coulombic efficiency, each of the cells was repeatedly charged and discharged 300 times or more at 0.33 C within a voltage range of 2.5 V to 4.25 V and discharged at 0.33 C at 45° C. and then, evaluated with respect to the number of cycles at a point where discharge capacity retention decreased to 80% of its initial discharge.

TABLE 1

| | | | | | | Comp. | Comp. |
|---|---|---|---|---|---|---|---|
| | | | Ex. 1 | Ex. 2 | Ex. 3 | Ex. 1 | Ex. 2 |
| Elastic sheet | Acrylate | | 100 | 100 | 100 | 100 | 100 |
| composition | copolymer | | | | | | |
| (parts by weight) | Crosslinking agent | | 0.1 | 0.1 | 0.1 | 0.1 | 0.1 |
| | Aluminum hydroxide | | 200 | 100 | 100 | 100 | — |
| | Inorganic nanotubes | | 0.1 | 0.1 | 0.1 | — | — |
| | Flame retardant | | 10 | 10 | — | — | — |
| | Polymer microsphere | | 0.5 | 0.5 | 0.5 | 0.5 | 0.5 |
| | Glass microsphere | | 1.5 | 1.5 | 1.5 | 1.5 | 1.5 |
| | Inorganic particles | | — | — | — | — | — |
| Properties of | Compressive strength | | 2.4 | 2.2 | 2.1 | 2.1 | 1.8 |
| elastic sheet | @ CFD 40% (MPa) | | | | | | |
| | Stress relief rate (%) | | 7.5 | 8.3 | 8.2 | 8.2 | 10.3 |
| | Recovery rate (%) | | 79 | 76 | 76 | 76 | 73 |
| | Thermal | horizontal | 3.613 | 2.132 | 2.935 | 1.45 | 0.795 |
| | conductivity | vertical | 0.615 | 0.377 | 0.405 | 0.209 | 0.122 |
| | (W/mK) | | | | | | |

| | | | | | | |
|---|---|---|---|---|---|---|
| | UL94 | VTM-0 | VTM-0 | VTM-0 | VTM-0 | NG |
| | Coulombic efficiency (%) | 93 | 92 | 93 | 92 | 89 |
| Electrochemical | Cycle-life | 300 | 300 | 300 | 130 | 270 |

| characteristics of | (the number of cycles) |
|---|---|
| all-solid-state | |
| battery cell | |

### (Elastic Sheet in Form of Dense Layer)

### Example 4

### (1) Manufacture of Elastic Sheet

An elastic sheet composition was prepared by mixing 0.1 parts by weight of 1,6-hexanediol diacrylate as a crosslinking agent, 200 parts by weight of aluminum hydroxide, 0.1 parts by weight of boehmite nanotubes (Boehmite, an aspect ratio: 40, Manufacturer: Aramis) as inorganic nanotubes, 10 parts by weight of aluminum diethylphosphinate (ADP, OMP-900; Manufacturer: Universal ChemTech. Co., Ltd.) as a flame retardant, and 50 parts by weight of spherical boehmite (D50: 300 nm) as inorganic particles based on 100 parts by weight of the acrylate copolymer of the preparation example.

The elastic sheet composition was applied on a polyethylene terephthalate (PET) film, which is a releasing film, and irradiated with ultraviolet rays at a light dose of 2000 mJ/cm² to manufacture an elastic sheet adhered on the releasing film. Subsequently, the releasing film was removed to obtain the elastic sheet.

(2) Manufacture of all-Solid-State Battery Cell

An all-solid-state battery cell was manufactured in the same manner as in Example 1 except that the above elastic sheet was used.

### Example 5

An elastic sheet and an all-solid-state battery cell were manufactured in the same manner as in Example 4 except that the inorganic particles were not used.

### Example 6

An elastic sheet and an all-solid-state battery cell were manufactured in the same manner as in Example 4 except that the flame retardant and the inorganic particles were not used.

### Example 7

An elastic sheet and an all-solid-state battery cell were manufactured in the same manner as in Example 4 except that 0.2 parts by weight of the inorganic nanotubes was used; the flame retardant and the inorganic particles were not used.

### Comparative Example 3

An elastic sheet and an all-solid-state battery cell were manufactured in the same manner as in Example 4 except that the inorganic nanotubes, the flame retardant, and the inorganic particles were not used.

### Comparative Example 4

An elastic sheet and an all-solid-state battery cell were manufactured in the same manner as in Example 4 except that the aluminum hydroxide, the inorganic nanotubes, the flame retardant, and the inorganic particles were not used.

### Evaluation Example 4: Evaluation of Mechanical Properties of Elastic Sheet

The elastic sheets of Examples 4 to 7 and Comparative Examples 3 and 4 were evaluated with respect to compression strength, a stress relief rate, and a recovery rate in the same manner as in Evaluation Example 1. The evaluation results are shown in Table 2.

### Evaluation Example 5: Evaluation of Thermal Properties of Elastic Sheet

The elastic sheets of Examples 4 to 7 and Comparative Examples 3 and 4 were evaluated with respect to thermal conductivity and flame retardancy grades in the same manner as in Evaluation Example 2. The evaluation results are shown in Table 2.

### Evaluation Example 6: Evaluation of Electrochemical Characteristics of all-Solid-State Battery Cell

The all-solid-state battery cells of Examples 4 to 7 and Comparative Examples 3 and 4 were evaluated with respect to coulombic efficiency and cycle-life in the same manner as in Evaluation Example 3. The evaluation results are shown in Table 2.

TABLE 2

| | | | | | | | Comp. | Comp. |
|---|---|---|---|---|---|---|---|---|
| | | | Ex. 4 | Ex. 5 | Ex. 6 | Ex. 7 | Ex. 3 | Ex. 4 |
| Elastic | Acrylate | | 100 | 100 | 100 | 100 | 100 | 100 |
| sheet | copolymer | | | | | | | |
| composition | Crosslinking agent | | 0.1 | 0.1 | 0.1 | 0.1 | 0.1 | 0.1 |
| (parts by | Aluminum hydroxide | | 200 | 200 | 200 | 200 | 200 | — |
| weight) | Inorganic nanotubes | | 0.1 | 0.1 | 0.1 | 0.2 | — | — |
| | Flame retardant | | 10 | 10 | — | — | — | — |
| | Polymer microsphere | | — | — | — | — | — | — |
| | Glass microsphere | | — | — | — | — | — | — |
| | Inorganic particles | | 50 | — | — | — | — | — |
| Properties | Compressive strength@ | | 2.9 | 2.7 | 2.6 | 2.6 | 2.6 | 2.0 |
| of elastic | CFD 40% (MPa) | | | | | | | |
| sheet | Stress relief rate (%) | | 5.8 | 5.8 | 6.3 | 6.3 | 6.5 | 6.8 |
| | Recovery rate (%) | | 89 | 88 | 85 | 85 | 75 | 73 |
| | Thermal | horizontal | 8.1 | 6.2 | 6.52 | 9.152 | 2.15 | 0.622 |
| | conductivity | vertical | 1.02 | 0.818 | 0.848 | 1.35 | 0.401 | 0.122 |
| | (W/mK) | | | | | | | |
| Flame | UL94 | | VTM-0 | VTM-0 | VTM-0 | VTM-0 | VTM-0 | NG |
| retardancy | | | | | | | | |
| grade | | | | | | | | |

| | | | | | | | |
|---|---|---|---|---|---|---|---|
| Electrochemical | Coulombic efficiency | 94 | 94 | 93 | 92 | 91 | 90 |
| characteristics of | (%) | | | | | | |
| all-solid-state | Cycle-life 300 | 300 | 300 | 300 | 300 | 95 | 85 |
| battery cell | (the number of cycles) | | | | | | |

### SUMMARY

Considering Tables 1 and 2, if the elastic sheets had the same shape, the elastic sheets (Examples) necessarily including a (meth)acrylate copolymer; aluminum hydroxide; and inorganic nanotubes, compared with the elastic sheets (Comparative Examples) excluding at least one of the (meth)acrylate copolymer; the aluminum hydroxide; and the inorganic nanotubes, exhibited overall excellent compressive strength, stress relief rate, recovery rate, thermal conductivity, and flame retardancy.

Furthermore, the elastic sheets of the examples having the characteristics as above turned out to improve cycle-life characteristics and coulombic characteristics of the all-solid-state battery cells.

On the other hand, the elastic sheets, which were in the form of a foam, had improved recovery properties, but the elastic sheets, which were in the form of a dense layer, had improved compressive strength and thermal conductivity. Accordingly, whether or not the pore-forming agent was used might be determined depending on desired characteristics.

By way of summation and review, some rechargeable lithium batteries may be lithium ion batteries that use an electrolyte solution including a flammable organic solvent, and may have safety issues such as explosion or fire when problems such as collision or penetration occur. Accordingly, an all-solid-state battery using a solid electrolyte instead of an electrolyte solution has been proposed.

One or more embodiments may provide an elastic sheet for an all-solid-state battery that help prevent damage to a solid electrolyte during the manufacturing process of the all-solid-state battery or the charging and discharging process of the manufactured all-solid-state battery, while allowing the components of the electrode assembly to have a uniform temperature thereby helping improve cycle-life characteristics and coulombic characteristics of an all-solid-state battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An elastic sheet for an all-solid-state battery, comprising:
a (meth)acrylate copolymer;
aluminum hydroxide; and
inorganic nanotubes.

2. The elastic sheet as claimed in claim 1, wherein:
the aluminum hydroxide is included in an amount of about 100 to about 300 parts by weight, based on 100 parts by weight of the (meth)acrylate copolymer, and
the inorganic nanotubes are included in an amount of about 0.01 to about 1 part by weight, based on 100 parts by weight of the (meth)acrylate copolymer.

3. The elastic sheet as claimed in claim 1, wherein the (meth)acrylate copolymer includes:
a first structural unit of a C1 to C20 linear alkyl (meth)acrylate,
a second structural unit of a C1 to C20 cyclic alkyl (meth)acrylate, and
a third structural unit of a C1 to C20 alkyl (meth)acrylate including a hydroxy group.

4. The elastic sheet as claimed in claim 3, wherein:
the first structural unit is included in an amount of about 30 wt % to about 70 wt %, based on a total weight of the (meth)acrylate copolymer,
the second structural unit is included in an amount of about 5 wt % to about 30 wt %, based on the total weight of the (meth)acrylate copolymer, and
the third structural unit is included in an amount of about 20 wt % to about 50 wt %, based on the total weight of the (meth)acrylate copolymer.

5. The elastic sheet as claimed in claim 3, wherein the (meth)acrylate copolymer is a copolymer of 2-ethylhexyl (meth)acrylate, isobornyl (meth)acrylate, and 2-hydroxybutyl (meth)acrylate.

6. The elastic sheet as claimed in claim 1, wherein the inorganic nanotubes include boehmite nanotubes, alumina nanotubes, boron nitride nanotubes, or a combination thereof.

7. The elastic sheet as claimed in claim 1, wherein an aspect ratio of the inorganic nanotube is greater than or equal to about 3.

8. The elastic sheet as claimed in claim 1, wherein:
the elastic sheet further includes an additive, and
the additive is a crosslinking agent, an inorganic particle, a flame retardant, a pore-forming agent, or a combination thereof.

9. The elastic sheet as claimed in claim 8, wherein:
the elastic sheet includes the crosslinking agent, and
the crosslinking agent is a multi-functional (meth)acrylate.

10. The elastic sheet as claimed in claim 9, wherein the crosslinking agent is included in an amount of about 0.01 parts by weight to about 1 part by weight, based on 100 parts by weight of the (meth)acrylate copolymer.

11. The elastic sheet as claimed in claim 8, wherein:
the elastic sheet includes the inorganic particle, and
the inorganic particle includes boehmite, alumina, or a combination thereof.

12. The elastic sheet as claimed in claim 11, wherein the inorganic particle is included in an amount of about 30 parts by weight to about 70 parts by weight, based on 100 parts by weight of the (meth)acrylate copolymer.

13. The elastic sheet as claimed in claim 8, wherein:
the elastic sheet includes the flame retardant, and
the flame retardant includes a phosphorus flame retardant or a melamine flame retardant.

14. The elastic sheet as claimed in claim 13, wherein the flame retardant is included in an amount of about 1 part by weight to about 30 parts by weight, based on 100 parts by weight of the (meth)acrylate copolymer.

15. The elastic sheet as claimed in claim 8, wherein:
the elastic sheet includes the pore-forming agent, and
the pore-forming agent is an inorganic pore-forming agent, an organic pore-forming agent, or a combination thereof.

16. The elastic sheet as claimed in claim 8, wherein a D50 particle size of the additive excluding the flame retardant is about 300 nm to about 20 μm.

17. The elastic sheet as claimed in claim 1, wherein the elastic sheet is in a form of foam or a dense layer.

18. The elastic sheet as claimed in claim 17, wherein:
the elastic sheet is in the form of foam,
CFD 40%, a compressive strength measured at a point compressed to 60% of an initial thickness, is about 0.5 MPa to about 3 MPa,
a stress relief rate according to Equation 1 is about 5% to about 20%,
a recovery rate according to Equation 2 is about 60% to about 95%,
a vertical thermal conductivity of the elastic sheet is about 0.3 W/mK to about 2 W/mK, and
a horizontal thermal conductivity of the elastic sheet is about 1.5 W/mK to about 5 W/mK:
Stress relief rate=100*(Stress after 60 seconds when compressed to 40% of initial thickness)/(Initial stress when compressed to 40% of initial thickness), [Equation 1]
Recovery rate=100*(Stress upon restoration to 60% of an initial thickness after compression to 40% of an initial thickness)/(Initial stress after compression to 60% of an initial thickness). [Equation 2]

19. The elastic sheet as claimed in claim 17, wherein:
the elastic sheet is in the form of a dense layer,
CFD 40%, a compressive strength measured at a point compressed to 60% of an initial thickness, is about 0.5 MPa to about 4 MPa,
a stress relief rate according to Equation 1 is about 5% to about 20%,
a recovery rate according to Equation 2 is about 60% to about 98%,
a vertical thermal conductivity of the elastic sheet is about 0.5 W/mK to about 2 W/mK, and
a horizontal thermal conductivity of the elastic sheet is about 3 W/mK to about 15 W/mK:
Stress relief rate=100*(Stress after 60 seconds when compressed to 40% of initial thickness)/(Initial stress when compressed to 40% of initial thickness), [Equation 1]
Recovery rate=100*(Stress upon restoration to 60% of an initial thickness after compression to 40% of an initial thickness)/(Initial stress after compression to 60% of an initial thickness). [Equation 2]

20. An all-solid-state battery, comprising:
the elastic sheet as claimed in claim 1; and
an electrode assembly,
wherein:
the electrode assembly includes a positive electrode, a negative electrode, and a solid electrolyte layer between the positive electrode and the negative electrode, and
the elastic sheet is outside at least one of the positive electrode and the negative electrode.
